(19) United States
(12) Patent Application Publication
(10) Pub. No.: US 2019/0220919 A1
(43) Pub. Date: Jul. 18, 2019

(54) SYSTEMS, METHODS, AND APPARATUSES FOR INDIVIDUAL-SPECIFIC DATA GENERATED BY SMART TAGS OF SOFT GOODS

(71) Applicant: LOOMIA Technologies, Inc., New York, NY (US)

(72) Inventors: Janett Martinez, Queens, NY (US); Solomon Lederer, New York, NY (US); Madison Thea Maxey, New York, NY (US)

(73) Assignee: LOOMIA Technologies, Inc.

(21) Appl. No.: 16/110,385

(22) Filed: Aug. 23, 2018

Related U.S. Application Data
(60) Provisional application No. 62/617,906, filed on Jan. 16, 2018.

(51) Int. Cl. G06Q 30/08; G06K 7/10; G06Q 20/36

(52) U.S. Cl. CPC G06Q 30/08; G06Q 20/367; G06K 7/10366

(57) ABSTRACT

A method for exchanging user data for compensation may comprise: receiving data from a user pertaining to usage of a soft good, wherein the data is obtained from one or more sensors coupled to the soft good; receiving bid information from a bidder, wherein the bid information pertains to an offer to purchase the data; transmitting or displaying at least a portion of the data to the bidder; and providing compensation to the user in exchange for providing the at least a portion of the data to the bidder.

### RELATED APPLICATIONS

This patent application claims the benefit under 35 U.S.C. § 119 to U.S. Provisional Patent Application No. 62/617,906, filed on Jan. 16, 2018, the entirety of which is incorporated herein by reference.

### TECHNICAL FIELD

The present disclosure relates generally to the field of generating, storing, and analyzing user data from smart tags, including the collection of data, authentication of a user's identity, and allowing authenticated user to access and manipulate collected data.

### BACKGROUND

Currently, individuals' identities may be defined by a string of numbers, dates, passwords, and images. For example, identifiers such as social security numbers, birthdays, and mother's maiden names are used across platforms and applications. Anyone with the digital assets of another individual can pretend to be that individual. Thus, individuals may be reluctant to collect and/or transmit data about themselves, and/or such data may be prone to misappropriation.

Companies that collect personal data about their users typically claim ownership of that data for themselves and make a profit reselling it to large corporations. Personal data is bought and sold at a premium behind closed doors in an opaque industry whose value might be anywhere from $156 billion to $300 billion.

### SUMMARY

In one aspect, a method for exchanging user data for compensation may comprise: receiving data from a user pertaining to usage of a soft good, wherein the data is obtained from one or more sensors coupled to the soft good; receiving bid information from a bidder, wherein the bid information pertains to an offer to purchase the data; transmitting or displaying at least a portion of the data to the bidder; and providing compensation to the user in exchange for providing the at least a portion of the data to the bidder.

In a further aspect, a system for facilitating exchanges of user data and compensation may comprise: a software platform configured to receive data pertaining to usage by a user of a soft good, wherein the data is obtained from one or more sensors coupled to the soft good; a data exchange platform configured to: receive bid information from a bidder, wherein the bid information pertains to an offer to purchase the data; provide at least a portion of the data to the bidder; and provide compensation to the user in exchange for providing the at least a portion of the data to the bidder.

In yet another aspect, a method for exchanging user data for compensation may comprise: receiving data from a user pertaining to usage of a soft good, wherein the data is obtained from one or more sensors coupled to the soft good; displaying to the user one or more bids for the data; receiving from the user an acceptance of at least one of the bids; transmitting or displaying at least a portion of the data to the bidder; and providing compensation to the user in response to the user's acceptance of at least one of the bids.

### BRIEF DESCRIPTION OF THE DRAWINGS

The accompanying drawings, which are incorporated in and constitute a part of this specification, illustrate exemplary embodiments of the present disclosure and, together with the description, serve to explain the principles of the disclosure.

FIG. 1 illustrates an exemplary smart article including a soft good incorporating a drapable, flexible electronic circuitry layer.

FIG. 2A illustrates an exemplary smart tag incorporated into an interconnect of a drapable, flexible electronic circuitry layer.

FIG. 2B illustrates an exemplary standalone smart tag.

FIG. 3 illustrates an example of how a soft good enhanced with a flexible electronic layer and/or smart tag may be used with an identity match algorithm to provide a wearer with access to secured facilities.

FIG. 4 illustrates an exemplary hardware and software system.

FIG. 5 illustrates an exemplary software platform.

FIG. 6 illustrates an exemplary method for registering a device on the blockchain.

FIG. 7 illustrates an example of how a user can preset sharing thresholds.

FIG. 8 illustrates an exemplary method for making a request for data.

FIG. 9 illustrates an exemplary method of identifying a user using biometric data.

FIG. 10 illustrates an exemplary user interface.

### DETAILED DESCRIPTION

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description.

Various non-limiting embodiments of the present disclosure will now be described to provide an overall understanding of the principles of the systems, methods, and apparatuses for personal data generated by smart tags disclosed herein.

The present disclosure describes a protocol for multi-factor identity verification that bridges the physical world and the digital world to prove that the physical individual is the digital individual. The currently disclosed systems and methods perform this by using personal data collected from individuals' soft goods, synced to an on-line profile, and optimally verified with a fingerprint or another identifying source of biometric data. In short, the currently disclosed systems and methods ensure that an individual is who they say they are by collecting personal data from what individuals wear.

The disclosed systems, methods, and apparatuses ensure that individuals' personal data continues to belong to those respective individuals. Instead of companies profiting from individuals' identities, individuals can own and sell their own data to brands, researchers, and/or other organizations or individuals who are interested in learning more about how individuals use their products and systems, thus creating a closed feedback loop with no intermediary and allowing individuals to profit from their own identities and data.

In the process, the presently disclosed system solves a key problem for brands as well: smart apparel alone is projected to be a $130 billion global market by 2025, and yet there is no good way to track the performance, use, and longevity of apparel and other soft goods once they leave a store. Customer research can cost a brand or research group upwards of $100,000 per product to conduct surveys and focus groups, predict product outcomes, track inventory, and evaluate marketing campaign reception. Even after doing all those steps, the information they get may be very incomplete, collected with very limited context. The presently-disclosed system provides an ethical way for brands and market researchers to obtain much more detailed data sets than ever before from a much larger number of users, without the effort and expense of mounting campaigns to harvest it themselves, and without users needing to take additional steps to provide it.

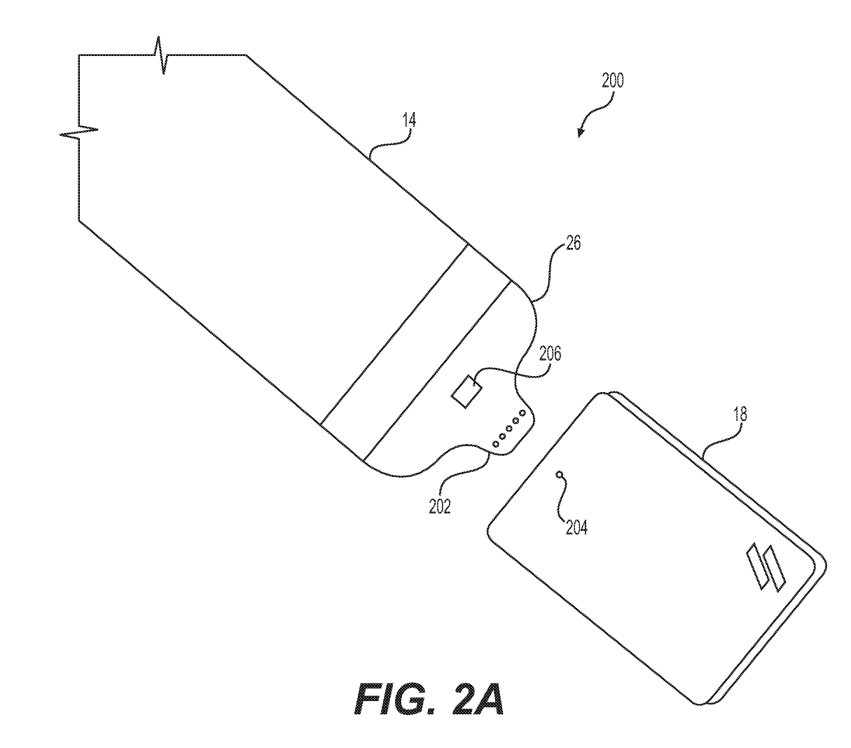

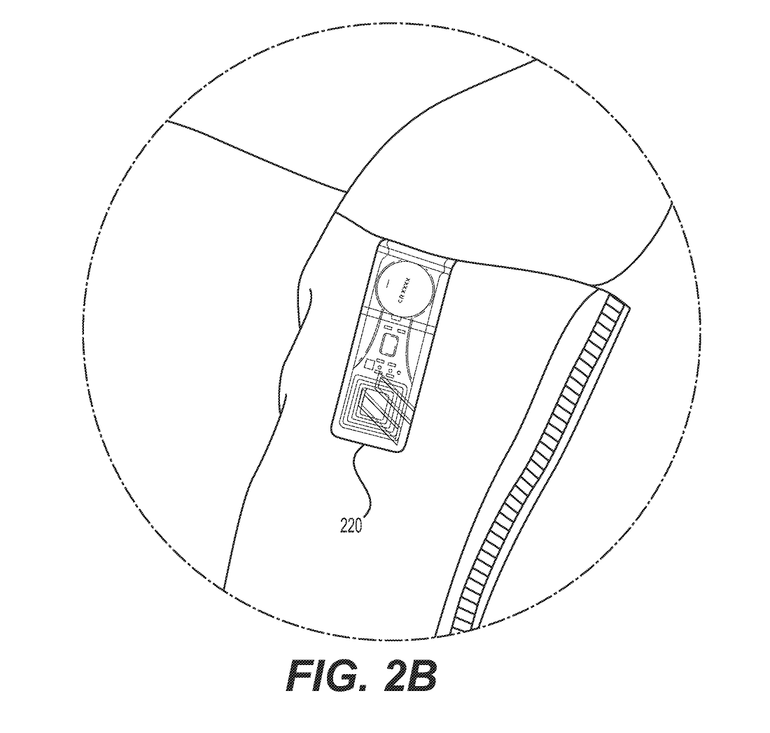

The presently disclosed solution includes a system with at least two levels: (1) a tile or tag, and (2) a system, which supports data exchange with the tile or tag (see FIG. 2). Herein, the tradename LOOMIA may be used for purposes of illustration and should not be construed as limiting.

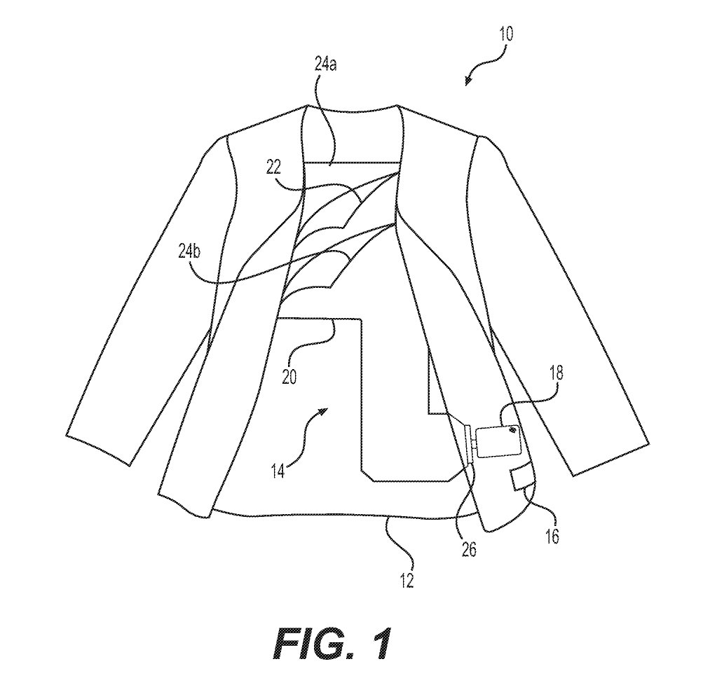

FIG. 1 depicts an exemplary smart article 10. Smart article 10 may include a soft good 12, a flexible circuitry layer 14, a smart tag 16, and an external device 18. Soft good 12 may be an item of clothing, such as a jacket, vest, shirt, pants, shorts, undergarment, sock, or other clothing item. Soft good 12 may also be, for example, an upholstered item such as furniture, a car seat, or another upholstered item. Soft good 12 may also be a hybrid soft and hard good, including, for example, a shoe or a tent. As shown in FIG. 1, soft good 10 is depicted as a jacket. However, such a depiction is not limiting.

Flexible circuitry layer 14 may form a soft, flexible electronic layer that moves like a fabric, but works like a circuit board. Circuits of flexible circuitry layer 14 may perform functions such as delivering heat and/or light and sensing changes in adjacent materials. Flexible circuitry layer 14 may include a circuitry trace portion 20. Circuitry trace portion 20 may include a circuitry trace layer 22, which may include conductive material capable of transmitting electricity. Circuitry trace portion 20 may also include a first insulating layer 24a and a second insulating layer 24b. Insulating layers 24a and 24b may sandwich circuitry trace layer 22 to make circuitry trace layer electrically and mechanically insulated. Circuitry trace portion 20 may be drapable, flexible, stretchable, and/or washable. Flexible circuitry layer 14 may perform a variety of functions including heating, lighting, and sensing functions. Flexible circuitry layer 14 may have a variety of inputs and/or outputs incorporated into various components of flexible circuitry layer 14. For example, flexible circuitry layer 14 may be used to gather data about a user of smart article 10. A size, shape, and function of flexible circuitry layer 14 may be customized for many different use cases. Because flexible circuitry layer 14 (including, for example, circuitry trace layer 22 and insulating layers 24a,b) may be made from soft components which may look and feel no different from fabric, flexible circuitry layer 14 may survive frequent machine washing and exposure to the elements, which may destroy other mechanisms like flexible PCBs. Flexible circuitry layer 14 may use certain features and techniques explained further in U.S. Patent Publication No. 2017/0086513, filed Sep. 26, 2016, U.S. patent application Ser. No. 15/994,415, filed May 31, 2018, and U.S. patent application Ser. No. 15/994,351, filed May 31, 2018, the entireties of each of which are incorporated by reference herein.

Flexible circuitry layer 14 may also include an interconnect 26. Flexible circuitry layer 14 may be pre-assembled with interconnect 26, which may be a hard-to-soft connection. Interconnect 26 may include a pitch transition zone for connecting high pitch electronic components (e.g., portions of circuitry trace layer 22) to lower-pitch electronic components such as transistors or other electronic components. Interconnect 26 may have a connector portion 202 (see FIG. 2A) that may permit interconnect 26 to connect to an external device 18. External device 18 may be, for example, a power source, memory, a controller, or any other type of device.

Smart article 10 may additionally or alternatively include a smart tag 16. Smart tag 16 may include one or more sensors or other inputs that are capable of collecting data. For example, smart tag 16 may include temperature sensors, motion sensors, and other types of inputs. The sensors may gather data continuously or at predetermined time intervals. Smart tag 16 may be a standalone device or may be integrated into a portion of flexible circuitry layer 14. Exemplary tile tags are further discussed in U.S. patent application Ser. No. 16/110,267, filed Aug. 23, 2018.

FIG. 2A shows an exemplary system 200 including a flexible circuitry layer 14 and external device 18. Flexible circuitry layer 14 may include an interconnect 26. Interconnect 26 may have a connector portion 202. For example, connector portion 202 may include a pogo pin connector, a USB connector, a headphone jack, a JST, or any other type of suitable connector. Connector portion 202 may fit into a mating portion, such as a receptacle, of external device 18. External device 18 may include an indicator 204. Indicator 204 may be, for example, a light, and may show that connector portion 202 is mated with a portion of external device 18. For example, indicator 204 may show that flexible circuitry layer 14 is receiving power from external device 18 or external device 18 is able to read data from circuitry layer 14.

Interconnect 26 may house components requiring logic (for example, a component such as an integrated circuit with the functionality of an Attiny85 microcontroller). Interconnect 26 may also include an interconnect tile tag 206, which may have any of the properties of smart tag 16, discussed above. Tile tag 206 may identify each unique soft good 12 with information about the brand, SKU, material, size, type, and more. Smart tag 16 may be an ID chip, as shown in FIG. 2A.

External device 18 may be, for example, a tile tag reader capable of reading information from tile tag 206. Tile tag 206 may be read by external device 18 when flexible circuitry layer 14 is plugged in via connector 202. Tile tag 206 may also be read by other readers when a user enters or leaves a location such as a store, attends an event, or boards transportation, which would enable it to work in third party applications as, for example, a ticket or an anti-theft device. For example, wireless technology such as Bluetooth, Wi-Fi, NFC, RFID, etc. could be used to read tile tag 206. Tile tag 206 could also be used during production of smart articles 10 to authenticate branding and ensure proper manufacturing processes all the way through the supply chain, while tracing the full lifecycle of the product from start to finish.

As shown in FIG. 2B, tile tag 220 may alternatively be a standalone component and may have any of the properties of tile tags 16 and/or 206, described above. Tile tag 220 may interact with one or more inputs in order to collect data. For example, tile tag 220 may interact with one or more components of flexible circuitry layer 14. In addition or in an alternative, standalone smart tag 16 may receive data from sensors unaffiliated with flexible circuitry layer 14. For example, one or more sensors may be mounted on tile tag 220. In an alternative, sensors may be mounted on soft good 12. Sensors may include, for example, motion sensors such as accelerometers and/or temperature sensors such as thermistors. Tile tag 220 may be configured to collect data from sensors and/or other inputs, such as those described above, and upload this data to external device 18 or to another device via a wireless connection such as NFC, RFID, Bluetooth, and/or Wi-Fi. In addition or in an alternative, tile tag 220 may be configured to upload data via a wired connection formed via a connector such as a pogo pin, USB, JST, and/or headphone jack. Tile tag 220 may include, for example, a power source such as a battery. In addition or in an alternative, tile tag 220 may be capable of harvesting energy from the environment. Such an energy-harvesting tile tag 220 tag may or may not include a power source such as a battery.

Tile tag 220 may be a soft or rigid tag that is sewn into a portion of soft good 220 or otherwise attached to soft good 12. Tile tag 220 may be fixedly or removably attached to soft good 12. In an alternative, tile tag 220 may be a token that may be carried by a user of smart article 10 in, for example, a pocket of soft good 12. Where a tile tag 220 is fixedly attached to a smart article 10, tile tag 220 may be configured for use with only that smart article 10. In an alternative, if tile tag 220 is detachable, smart tag 16 may be configured for use with multiple smart articles 10. For example, a user may move tile tag 220 from one smart article 10 to another smart article 10.

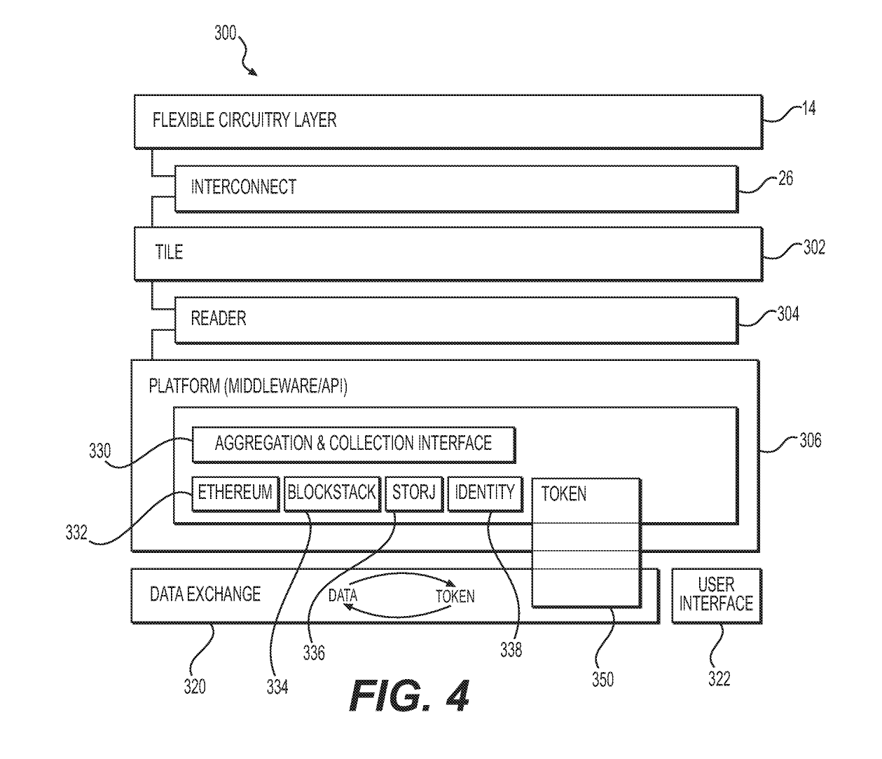

Tile tags 16, 206, and/or 220 may serve a variety of functions, alone or in conjunction with a device such as external device 18. For example, any of tile tags 16, 206, and/or 220 (alone or in combination with external device 18) may serve as a user's “keychain” with multiple soft goods 12 belonging to an individual registered as “keys,” gathering all of the data collected through them in a single place. For example, a user may sync information from multiple flexible circuitry layers 14 and/or other inputs across multiple smart articles 10 using tile tags 16, 206, and/or 220 (along or in combination with external device 18). Flexible circuitry layer 14 or another component of smart article 10 may have a unique identifier such as a SKU. With respect to a smart tag 16, 206, and/or 220 that is not detachable from a smart article 10, smart tag 16, 206 and/or 220 may be synced with a device such as external device 18, which may facilitate syncing information across multiple smart articles 10. Tile tags 16, 206, and/or 220 and/or external device 18 may store data from smart articles 10 until syncing with a software platform, such as the systems described below (see FIG. 4). In some examples, each circuitry layer 14 may pass a specific resistance from its smart article 10 to external device 18 and/or tile tags 16, 206, and/or 220, allowing external device 18 and/or tile tags 16, 206, and/or 220 to identify that article 10 uniquely through a general-purpose input/output (GPIO) pin or other connector mechanism. In other examples, a chip may be used as an identifier. Thus, external device 18 and/or tile tags 16, 206, and/or 220 can collect data about the specifications of use of article 10.

When being used as a “keychain” or in other applications, tile tags 16, 206, and/or 220 may collect data about the specifications of a soft good 12 (e.g., size, color, etc.), the use of soft good 12, how many times the soft good 12 was worn or used, and duration, timing, and location of use of soft good 12.

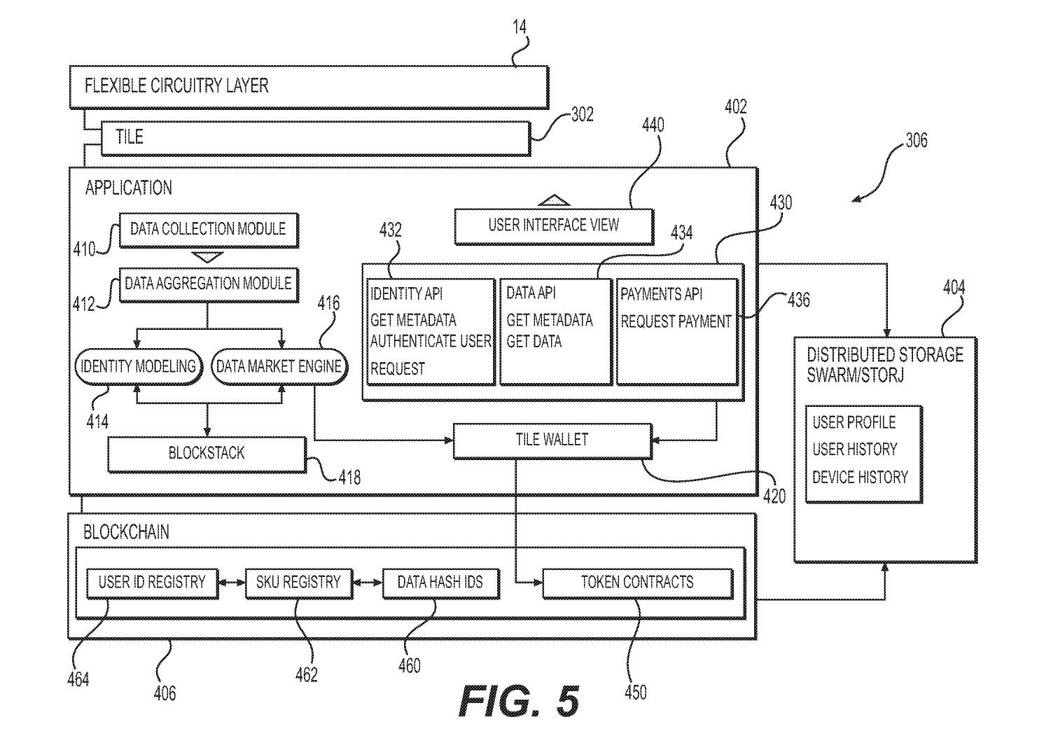

In addition or in an alternative, external device 18 and/or tile tags 16, 206, and/or 220 may act like a “MetroCard” or other type of payment device, which individuals can reload with tokens (such as tokens 350, described below) or other forms of currency in order to make purchases or engage in other transactions. Such tokens and/or currency may be obtained through the processes described below with regard to FIGS. 4, 7, and 8 and transactions may be facilitated by any of the systems described herein, such as those described in FIGS. 4 and 5. NFC, RFID, Bluetooth, and/or Wi-Fi chips may facilitate approval of transactions and may facilitate converting currency from one form to another. For example, tokens may be converted seamlessly into other digital currencies.

External device 18 and/or tile tags 16, 206, and/or 220 may have unique identifiers. Multiple devices such as external device 18 and/or tile tags 16, 206, and/or 220 may work together to give a high degree of confidence in confirming identity. For example, unique identifiers may be present on an integrated chip. External device 18 and/or tile tags 16, 206, and/or 220 may use a blockchain-friendly chip for identification. The chip may have a device ID, a public key, and a private key. A chip could be a Chronicled chip, or another chip compatible with blockchain integration.

A user may connect external device 18 and/or tile tags 16, 206, and/or 220 with one or more software applications (including those described with regard to FIG. 4, below) and/or hardware device. A software application used may reside on any suitable device, including a personal computer, a smartphone, a cloud server, or any other device. Similarly, a suitable hardware device may be a standalone device or may be a component (such as a near field communication (NFC) chip on a smartphone). A connection may be made using wired or wireless connections such as Bluetooth, NFC, and/or Wi-Fi. In addition or in an alternative, a smartphone may be used to scan external device 18 and/or tile tags 16, 206, and/or 220, using, for example, an optical or RFID scanner.

Any or all of external device 18 and/or tile tags 16, 206, and/or 220 may be docked using a physical or virtual dock. Docking may facilitate connection to a software system such as that depicted in FIG. 4 in order to view, distribute, or otherwise manage data. Docking may also recharge a battery of external device 18 and/or tile tags 16, 206, and/or 220 and/or a battery of flexible circuitry layer 14. Fingerprint or other biometric indicators may facilitate docking. Certain actions may be automatic upon docking (e.g., charging), while other actions may require user intervention (e.g., data upload and/or management).

Device 18 and/or tile tags 16, 206, and/or 220 may serve to activate functions on a connected software application or hardware device. In addition or in an alternative, a connected software application and/or hardware device may serve to activate functionality of device 18 and/or tile tags 16, 206, and/or 220. For example, after being scanned with a smartphone, device 18 and/or tile tags 16, 206, and/or 220 may perform functions based on a user's previous preferences and needs. In time, these decisions may become increasingly complex, such as setting the temperature of a garment based on the user's ideal body temperature or making payments automatically to the user's favorite coffee shop. Interface elements in smart articles 10 may be used to automate or expedite many interactions that currently require a smartphone, such as checking-in on services like Yelp, Facebook, and Foursquare and/or making mobile payments.

Components of smart article 10 (including, for example, external device 18 and/or tile tags 16, 206, and/or 220) may have the capacity to support “multi-signature” identity verification schemes. For example, components of smart article 10 may be compatible with numerous possible security thresholds. For example, in a low security scheme, the presence of an individual's registered smart article 10, external device 18, and/or tile tags 16, 206, and/or 220 may serve to verify a user's identity. In a medium security scheme, other factors such as an individual's gait (e.g., determined by an accelerometer) and measurements of an individual's usual bodily and environmental conditions may be used. In a high security scheme, fingerprint recognition may be used. Any of the above metrics may be used in combination.

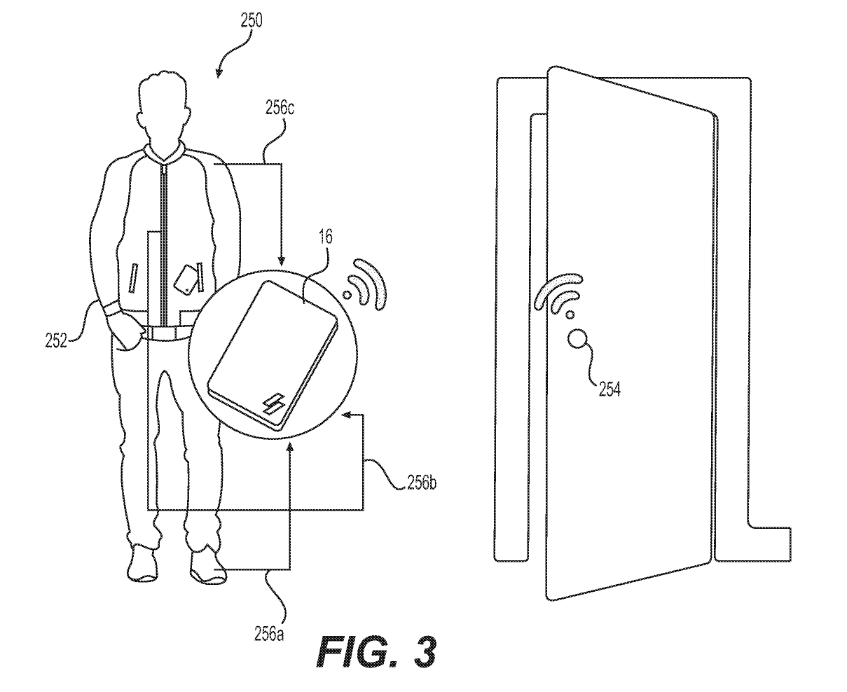

For example, FIG. 3 depicts a mechanism 250 for verifying an identity of an individual 252. Once an identify of an individual 252 is verified to a certainty above a pre-determined threshold value, individual 252 may be given access to an access point 254. While access point 254 is depicted as a physical entrance, access point 254 may also provide access to technology such as a phone, computer, or other personal device or to a virtual environment, such as a system 300 discussed below with regard to FIG. 4. External device 18, and/or tile tags 16, 206, and/or 220 may serve to agglomerate data from numerous sources. In addition or in an alternative, external device 18, and/or tile tags 16, 206, and/or 220 may serve as a source of data used to verify an identity of an individual 252 according to mechanism 250. While FIG. 3 shows external device 16 agglomerating data, such a configuration is merely exemplary.

As shown in FIG. 3, one or more identification sources 256 may be used. For example, identification sources may include gait information 256a, bodily condition 256b, and smart article identity information 256c. Bodily condition 256b may be, for example, an identifier such as a heart rate, temperature, height, weight, eye color, or any other identifier. External device 18 and/or tile tags 16, 206, and/or 220 may collect data from identification sources 256. For example, gait information 256a may serve to verify an identity of individual 252 at a certainty of 30%. Bodily condition 256b may serve to verify an identity of individual 252 at a certainty of 40%. Smart article identity information 256c may serve to verify an identity of individual 252 at a certainty of 20%. Thus, identification sources 256 combined may serve to verify an identity of individual 252 at a certainty of 90%. A score from identification sources 256 may be transmitted to an access point 254 by, for example, scanning smart tag 16, a wireless internet connection, NFC, Bluetooth, or another mechanism. A communicated certainty level of a total of identification sources 256 may be compared to an access threshold of access point 254. For example, if an access threshold of access point 254 is 85%, a score of 90% will permit access. On the other hand, a score of 80% would not allow access. While FIG. 3 shows three exemplary identification sources 256, mechanism 250 may use more of fewer identification sources 256.

FIG. 4 depicts an exemplary system 300 including hardware and software components. Exemplary components of system 300 include flexible circuitry layer 14, interconnect 26, smart tag 16, reader 304, platform 306, and data exchange 320. Data exchange 320 may be a data exchange platform. System 300 may work with, for example, system 200, described above with regard to FIG. 2A. Flexible circuitry layer 14/and or interconnect 26 may include a tile tag such as tile tags 16, 206, and/or 220, described above.

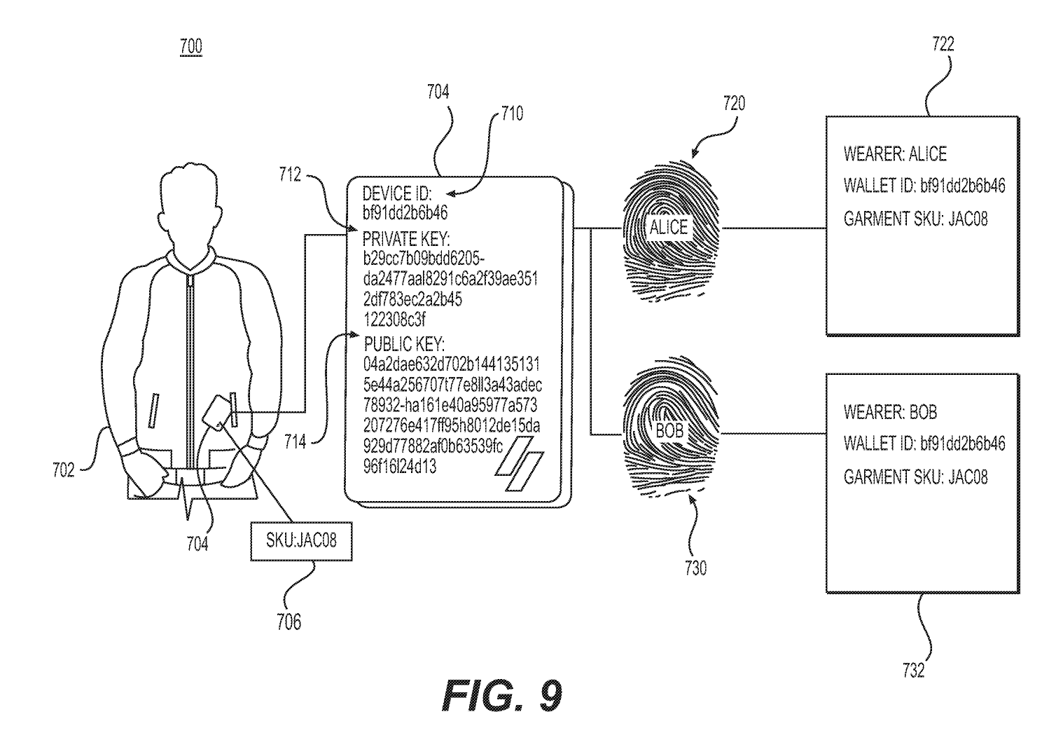

System 300 may also include a tile 302. Tile 302 may be a hardware device that stores data gathered until it is synced into platform 306. For example, external component 18, described above, may function as a tile 302. Tile 302 may also be a smart tag 16, 206, and/or 220. In addition or in an alternative, tile 302 may be on board flexible circuitry layer 14 and/or interconnect 26. Tile 302 may interface and/or synchronize with platform 306 via any suitable wired or wireless connection. For example, tile 302 may be equipped with any type of Bluetooth, Wi-Fi-enabling, NFC, optical scanning, and/or RFID technology. In an alternative, tile 302 may be able to form a wired connection with platform 306 via any suitable type of connector such as a pogo-pin connector, a USB connector, a headphone jack, or a JST connector. For example, where tile 302 is an external device 18, a receptacle of external device 18 used to connect to connector portion 202 may be used to interface with platform 306. Tile 302 may include a reader 304, which is used for reading data from flexible circuitry layer 14, interconnect 26, and/or tile tags such as tile tags 16, 206, and/or 220. In addition or in an alternative, reader 304 may serve to interface tile 302 with platform 306. Fingerprint recognition may be incorporated in order to verify users' identities (see, e.g., FIG. 9). A user interface 322 may be used to facilitate interactions between tile 302 and platform 306 or other components of system 300.

Platform 306 may be a peer-to-peer (P2P) serverless application or may use a central server. Platform 306 may collect, manage, and/or store the data collected tile 302, integrate it through a blockchain protocol to verify users' identities and data integrity, and give users the ability to sell their personal data to brands and/or third parties. In an alternative, platform 306 may not use blockchain to verify user identities and may use other identity-verifying mechanisms. Platform 306 will be described in further detail below, with regard to FIG. 5.

Platform 306 may include an aggregation and collection interface 330, which may be used to aggregate and/or collect data. Aggregation and collection interface 330 may work with other components of platform 306 in order to effectively store and use data. Use of any tradenames or trademarks herein are for merely exemplary purposes. A wide variety of systems may be used, including those similar to those enumerated below. For example, platform 306 may utilize Ethereum 332, Blockstack 334, Storj 336, and/or Identity 338 for purposes of providing a decentralized platform, storage, and/or identity verification. Further details of these and other systems are described below with regard to FIG. 5.

Data exchange 320 may be an on-line or other type of virtual marketplace through which parties such as brands, researchers and third parties (which might include, for example, restaurants, banks, or transit authorities) may purchase data directly from users. In addition or in an alternative, a host of data exchange 320 and/or platform 306 may purchase data from users on behalf of one or more third parties. Data transmitted via data exchange 320 may be aggregated with data from, for example, other users in order to study potential product and service improvements. For example, such aggregated data may pertain to properties of a user, smart article 10, soft good 12, circuitry layer 14, external device 18, and/or tile tags 16, 206, and/or 220. Data transmitted via data exchange 320 may be delivered in an anonymized manner, with no identifying information included in the exchange beyond a user's public key or other public identifier on platform 306. In addition or in an alternative, a user may choose to disclose identifying information.

Users may be compensated for making data available on data exchange 320. For example, users may be compensated via currency (including crypto-currency) or another mechanism. For example, compensation may be made with tokens 350 which may be converted directly into other currencies (including digital currencies) or exchanged for special rewards with brands and third parties interacting with system 300, including via platform 306 and/or data exchange 320. Token 350 may be an Ethereum ERC20 token. In some cases, token 350 may be transferred freely between users directly on a blockchain, such as the blockchain described below with regard to FIG. 5. Token 350 may also be used by third party applications that may connect to platform 330 or another portion of system 300.

Thus, companies and interested researchers may gain novel and accurate data sets, while users may earn compensation. Because the data on external device 18, and/or tile tags 16, 206, and/or 220 may be encrypted, other parties aside from a user who owns the data may not be able to use it until it is sold or otherwise made available by the user.

Data may be visualized using user interface 322. User interface 322 may permit users to view their data before deciding which data to decrypt and transmit via data exchange 320. In some cases, data may only become available to interested parties once the user decides to make the data available; the user may retain the right to choose what data they will share, as well as when they will share it, and with whom. For example, a user might choose to share their biometric data in exchange for health and fitness rewards while keeping their location data confidential. Interested parties can incentivize users to make available kind of data the interested parties find most useful by providing different kinds of rewards, and users can incentivize brands to align with their lifestyle by making their data available in exchange for the rewards they value most. In order to view their data, store it for future use, or sell it on data exchange 320, a user may first sync (e.g., by docking) external device 18, and/or tile tags 16, 206, and/or 220, as described above with regard to FIGS. 2A-2B and 4.

FIG. 5 depicts further details of platform 306. Platform 306 may include multiple distributed applications working together. As shown in FIG. 5 and described above with regard to FIG. 4, platform 306 may interface with tile 302 and/or flexible circuitry layer 14. For example, platform 306 as depicted in FIG. 5 may include three distributed applications: (1) a platform application 402 for user interactions and data collection, (2) decentralized data storage 404 for long-term housing and retrieval of data; and (3) blockchain 406 for distributed, verifiable, universal record keeping and transaction execution.

Platform application 402 may be responsible for a variety of functions. For example, platform application 402 may be responsible for collecting the data from tile 302. A data collection module 410 and data aggregation module 412 may assist with collecting and aggregating data. A user may synchronize tile 302 with platform application 402 using any of the mechanisms described above with regard to FIG. 4. For example, a user may synchronize tile 302 at given time intervals, such as at the end of each day. In an alternative, tile 302 may continuously synchronize with platform application 402 so long as a connection is available. Platform application 402 may also register new tiles 302 and/or components of smart article 10, including tile tags 16, 206, and/or 220 by making connections with tiles 302 and/or other components, including components that interface with tiles 302.

Collected and/or aggregated data may be subject to identity modeling in module 414 and may also be processed by data market engine 416. Identity modeling module 414 and data market engine 416 may store data in blockstack 418. Data market engine 416 may also interface with virtual tile wallet 420 to store data, currency, and/or tokens 350 for current or later use. Currency obtained from selling data may be deposited in tile wallet 420. Tile wallet 420 may interface with various APIs, including an identity API 432, a data API 434, and a payments API 436. Platform application 402 may aggregate data synced from tile 302 and provide visualization of the data to a user via, for example, user interface view 440. User interface view 440 may have any of the qualities of user interface 322, described above.

Platform application 402 may also match data synced from tile 302 against models of realistic, genuine data. Platform application 402 may limit the amount of data that can be loaded in a given time period, in order to prevent fraudulent data from being loaded into the platform. For example, if a user is loading data daily, then the user may only be able to upload an amount of data that can be reasonably collected in a day. Models used by platform 306 may be calibrated among peers and adjusted over time. Platform 306 may also encrypt data and back it up to decentralized data storage 404 or to other external storage venues chosen by the user.

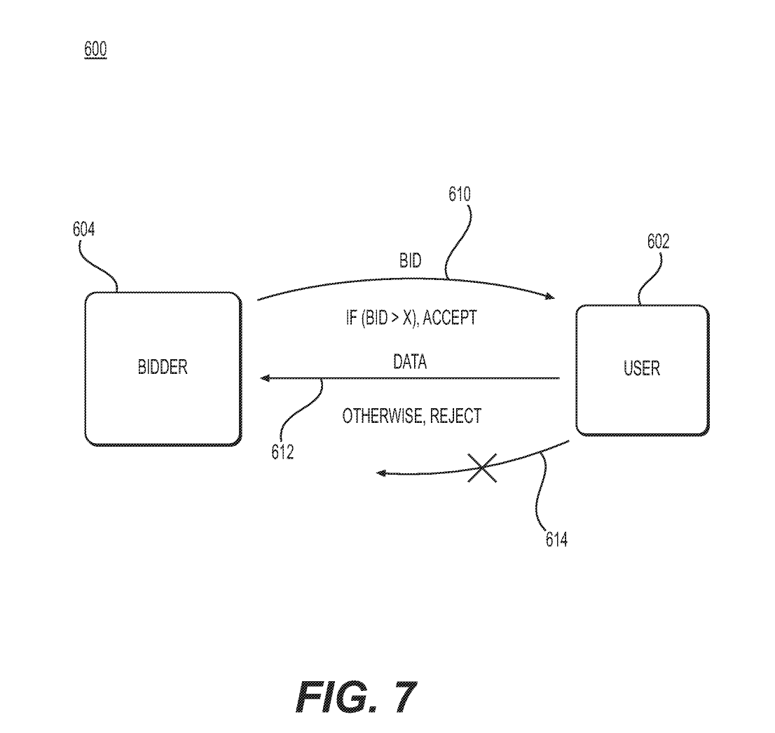

Platform application 402 may additionally allow users to make their data available to third parties. As shown in FIG. 7, and discussed in further detail below, exchanges of data and currency may occur according to preset thresholds. A user may choose to keep all their data locked down or automatically sold upon an offer. An automatic sale may be limited based on the type, sensitivity, and size of data being released. A sale may also be restricted based on the payment amount being offered, and/or the reputation of the buyer. Over time, prices for data may be calibrated to match the supply and demand for information in data exchange 320. The process of receiving payments in the form of tokens 350 or other currency and spending those tokens or currency to get rewards may be managed by the user's wallet 420 inside of platform application 402.

Because users may be holding important and valuable data, it may be useful to have a seamless backup system such as decentralized data storage 404. In an alternative to decentralized data storage 404, local memory or other storage may be used. Decentralized data storage 404 may store information including, for example, user profile information, user history information, and/or history of a device such as external device 18, tile tags 16, 206, and/or 220, and/or tile 302. Exemplary but not limiting storage mechanisms are described below. Platform 306 may back up encrypted data-chunks to systems such as Dropbox. In an alternative, platform 306 may utilize blockchain-based distributed storage system Storj or other blockchain-based systems. If a user's tile 302 or app allowing access to system 300 becomes lost or corrupted, everything may be reclaimed from this distributed storage. For example, a user's private key or other private identifier may be used to decrypt their data capsule. Platform 306 may be designed to be storage agnostic. In one example, Storj may be integrated with platform 306. Storj creates encrypted portions of a file called shards which are stored redundantly throughout the network. The routing is built on Kademlia, a distributed hash table (DHT) allowing for a distributed network with efficient message routing. Storj adds additional message types to support Quasar, a peer-to-peer publish/subscribe system.

In one example, Swarm may be used for convenience in working on the Ethereum platform, which means Swarm's distributed preimage archive (DPA) protocol for storage as well as the bzz:/ protocol for sending and retrieving data may be used. Swarm's DPA protocol stores information in strings of bytes according to their hash value, which are assumed to be collision-free, just like Ethereum addresses. The repository of data stored through the DPA is the Distributed Hash Table (DHT), in which each node has an address that is within a short distance of the hashes of the data it has contributed. In some cases, nodes may store only the data whose hashes are closest to itself, and once a node reaches storage capacity, it will discard the data whose hashes are furthest away. Thus, each node has the ability to add new data to the DPA, retrieve data which it has previously stored, and provide routing information to nodes which are closer to the data being retrieved. Each node also breaks large chunks of data into a tree of smaller blocks, in which the key of each root block can be used to retrieve its children until the whole data chunk is reassembled.

Blockchain 406 may provide an alternative source of data storage that is decentralized. Blockchain 406 may communicate with tile wallet 420 and may include token contracts 450, data hash IDs 460, SKU registry 462, and user ID registry 464. Blockchain 406 may provide transaction validation, acting as a mechanism for transaction verification and off-chain transactions that ensure data is real data. Blockchain 406 may also provide a constant backbone to ensure data authenticity, so that individual nodes can join and leave the network without impact on the network's integrity and operations. Blockchain 406 may ensure that zone files are correct by matching the hash for the file stored on blockchain 406 with the hash retrieved from distributed storage 404 by, for example, using data hash IDs 460. This may allow users to connect and get correct routing information for communicating with the rest of system 300 or other devices or users using system 300. The routing algorithm used by platform 306 or other portions of system 300 may leverage systems such as Blockstack and Kadmelia routing. Blockchain 406 may also be used to facilitate a peer-to-peer rewards system using a currency such as tokens 350.

Features of the blockchain 404 may include one or more of the following exemplary features. Blockchain 404 may include a directory of every registered smart article 10 (or components of smart articles 10), for example in SKU registry 462. This directory of SKUs or other identifiers may be updated every time new products enabled for use with smart articles 10 are manufactured. When a new product is authenticated by the platform application 304, it may check this registry to ensure that it is an authentic, branded or licensed product.

Blockchain 404 may also include aggregated user data, which may be periodically hashed and written to the blockchain 404, creating a history that is verified in time. For example, such data may be stored in user ID registry 464. The length of this time series of hashes may impact a user's identity score. This may act as a cryptographic secure tagging of IDs. Blockchain 404 may also include payment rails, which may enable the user to transfer tokens to other users inside of LOOMIA and to other integrated distributed storage platforms such as Storj, Sia, or Filecoin.

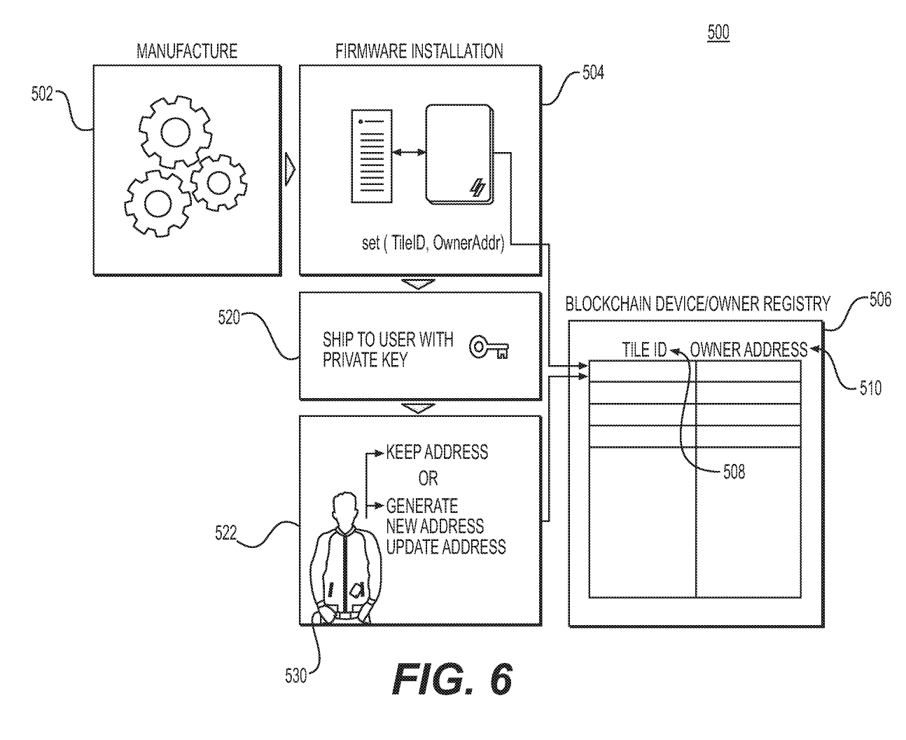

As shown in FIG. 6, all smart articles 10 or components thereof produced by a particular producer may be registered on blockchain 406 using method 500. As shown in block 502, a smart article 10 or component thereof may be manufactured by an authorized manufacturer. As shown in block 504, in a post-manufacturing phase, a public/private key pair may be generated for smart article 10 or a component thereof. The generated public address may be written to blockchain 404 with that item's ID. This address may represent the owner of the product.

As shown in block 520, purchasers may receive an assigned private key of the blockchain address. As shown in block 522, the purchaser 530 can then choose to update the owner address to one of their choosing, or to keep the address generated for them (which may be less secure, but more convenient). In some examples, the update method may only be invocable by the owner. Information installed with firmware in step 504 and/or updated by user 530 in step 522 may be stored in owner registry 506. For example, owner registry 506 may include information regarding a tile ID 508 and/or an owner address 510.

When updating blockchain 404 with a new record, platform application 402 may create and store a hash of that record. The smart contract may verify the addition is valid, for instance, by verifying that that the device record has not been updated within 24 hours. The number of records added may be monitored and/or restricted to prevent false record entries. For example, in some examples there may be a limit to the number of records that can be uploaded over a preset time period, such as an hour or a day. The below code provides an example of a new data hash that may be created from a group of entries every 24-hour period.

function addNewRecord(string deviceId,

address deviceOwner,
bytes32 newDataHash)

{
uint lastEntrytime =

records[deviceId].entryTime;

if (now >= lastEntryTime + 24 hours

&& records[deviceId].owner ==

deviceOwner) {

records[deviceId].entryTime = now;
records[deviceId].dataHash =

newDataHash;

}
}

When data is transferred to a third party (such as a buyer), the record may be produced along with the transaction showing that hash of that data written to the contract. In this way, data cannot be falsified after the fact.

In some cases, platform 304 may not include provisions for buying and selling data, but may collect all of the data about users' smart articles 10 (including soft goods 12) in one system, from which users can easily retrieve the data to provide proof of purchase or to claim support under warranties and get replacements or repairs for damaged goods. When platform 304 includes provisions for buying and selling, users may earn rewards when they sell their own data on data exchange 320, as described above and further detailed herein.

Before a user chooses whether to sell their data, platform application 402 may sort data into many different categories, which may allow both users and buyers to be selective about what kind of data they want to sell and acquire. Some categories may be defined according to the World Economic Forum's conventions for classifying personal data.
Volunteered data: completed survey forms, profiles, and other attestations written by users explicitly for the use of researchers
Observed data: recordings of the action or condition of the user, which can be captured by researchers without any conscious effort or declaration by the user
Inferred data: conclusions about the user drawn from statistical analysis of volunteered or observed data, similar to credit scores

Other exemplary categories may sort data by its structure, rather than its content:
Independent data points: how often a user is doing a particular activity or interacting with a given smart article 10 (for instance, wearing a given jacket, or going outside in cold weather).
Related data points: how often two independent data points correlate (e.g. wearing a given jacket while going outside in cold weather).
Static data points: identity parameters which broadly define the marketing demographic and basic persona of the user, independent of detailed product-use behaviors

Turning to FIG. 7, user 602 may engage with a bidder 604 in bidding environment 600. In data exchange 320, bidders 604 can broadcast their interest in and price point for buying specific kinds of data in step 610. In some versions of data exchange 320, a manual, centralized bidding process may occur. In other versions of the data exchange 320, a bidding process may be decentralized. Bidders 604 may include a wide range of third parties like delivery services and city planners, in addition to product brands.

In response, users 602 can sell each kind of data manually, or set data to be released automatically at a certain price point or to a certain buyer. User 602 or another data owner may preset their sharing thresholds. In step 612, for example, if a bidder 604 is offering more than “x,” user 602 may automatically sell the data. Otherwise, user 602 may not be included in data purchasing by bidder 604 and a bid may be rejected in step 614.

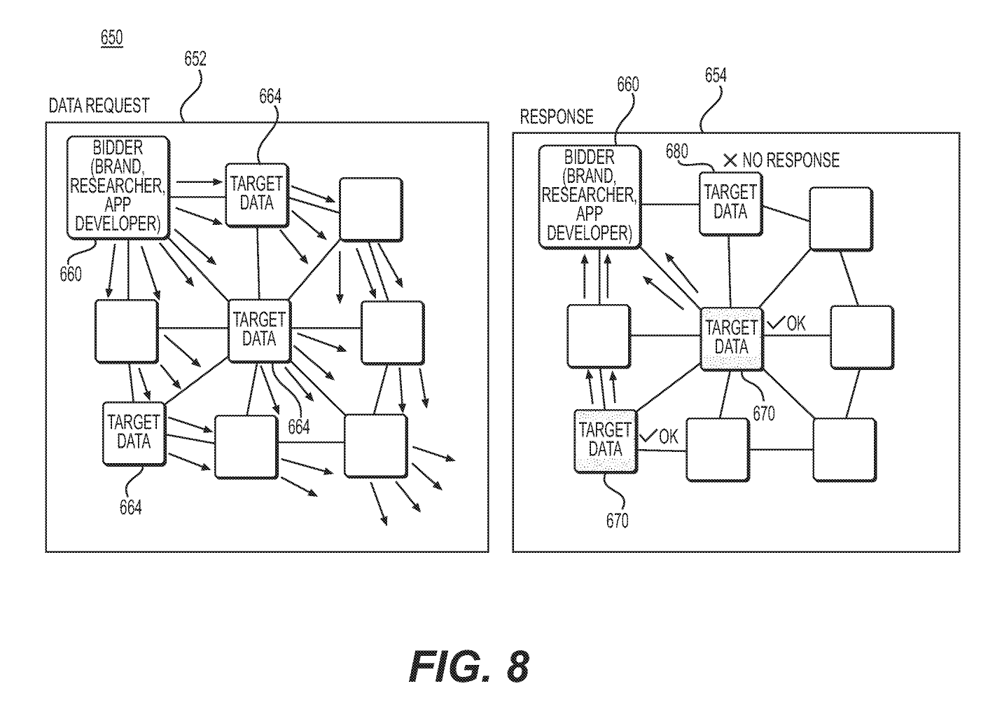

FIG. 8 shows a system 650 for providing data requests 652 and responses 654. A request for data from bidder 660 (which may have any of the characteristics of bidder 604) may be sent to various nodes 664, which may represent users or groups of users. Bidder 660 may receive target data from a subset 670 of nodes 664 that have compatible threshold settings (e.g., as shown in FIG. 7) with bidder 660. Data will not be received from a subset 680 of nodes 664 that do not have compatible threshold settings (e.g., as shown in FIG. 7) with bidder 660. In exchange for their data, users may receive currency such as tokens 350. Such currency may be deposited into a user's wallet 420 in platform application 402.

When a bidder 660 makes a request for some type of data, the request may flow through a network of users, such as users 602, using system 300 in order to reach some or all users 602, indicating an amount that will be paid on fulfilling the request. Each platform application 402 of each user 602 may reply with the data requested if it meets the threshold requirements set by user 602 (see FIG. 7). In addition or in an alternative, a bidder such as bidder 660 and/or 604 may pay for access to data that has already been authorized for release by user 602. Such payment may be made by currency such as tokens 350 or any other kind of currency. For example, if a brand wanted to determine how many users 602 wear its jacket, the brand may spend currency such as tokens 350 to query platform 306 to get usage data. In addition or in an alternative, system 300 may manually facilitate bidding and data purchasing processes. For example, if a brand wanted to determine how many users wear their jacket, it would spend tokens to query the Tile Platform to get usage data.

In some cases, a device such as external device 18 or tile tags 16, 206, and/or 220 may use manual authorization for payments. For example, external device 18 or tile tags 16, 206, and/or 220 may use an indicator light such as indicator 204 to display a signal about the payment. In addition or in an alternative, external device 18 or tile tags 16, 206, and/or 220 may make small automatic payments below a certain threshold, or larger automatic payments for parties with strong reputations and well-verified identities, which could allow for checkout-free shopping and dining. System 300, including platform 306, may also provide service opportunities. For example, system 300 may allow parties to assign a certain percentage of their currency obtained via data exchange 320 to other parties, such as to a factory worker who article 10, or to other causes which the party may support.

Turning to FIG. 9, in some examples, a unique identifier may become associated with a user when external device 18 and/or tile tags 16, 206, and/or 220 reads a fingerprint and associates itself with that user. User 702 may upload data from tile 704, which may have any of the characteristics of external device 18, tile tags 16, 206, and/or 220, and/or tile 302. Tile 704 may be identified with a SKU or other identifier 706, as well as a device ID 710, private key 712, and public key 714. Tile 704 may be used by multiple individuals, such as “Alice” and “Bob.” Alice may associate data from tile 704 with her profile 720 by presenting fingerprint 720. On the other hand, if Bob presents his fingerprint 730, the uploaded data will be associated with his profile 732. Thus, a fingerprint may be used in order to associate the uploaded with the account belonging to the owner of the fingerprint presented, which may not be the owner of tile 704. Thus, tile 704 may not be a personalized item that can be stolen along with the data and currency associated with them. Instead, it may be an interface that can be personalized to any user with the touch of a finger. Even if two users, Alice and Bob, share both a smart garment 10 and tile 704, Alice can only access her data, and Bob can only access his.

The ability of tile 704 to confirm a user's identity reliably through fingerprint or other biometric sources has many applications. For example, web services may query a user's address to get their identity attestations, as well as a score describing the probability that each attestation is true. For example, the system 300 may rate someone to likely be above 21 years old if they go to bars and casinos and if their immediate social circle is over 21. Each user may build an identity profile through the course of their interactions with system 300; as the user contributes more data, their identity profile grows, and other users can verify them with greater confidence. Thus, in some examples, system 300 may be used to check whether a user has clearance to enter secured facilities, to unlock the user's car or home, to inform them of severe weather conditions in their area, or to share their location with other members of their social network, among many other examples.

As described herein, users may wear or use smart articles 10 which collect data including, but not limited to, users' use patterns, their location, their body temperature, their body motions, and their environmental conditions, which may all be tied to the an identifier of smart article 10 or soft good 12, such as a SKU. Smart articles 10 and components thereof such as garments may store data points during the day and transfer them to data exchange 320 only if the user wishes to share their data. Simply by going about their day, users may create data sets, which may in turn provide brands with meaningful insights about how their products are being used.

Using system 300, users can sell their data to researchers and other interested buyers in an anonymized fashion in exchange for currency such as tokens 350. Tokens 350 may be converted to other digital currencies or used across businesses system 300, offering a wide economy in which token 350 has value. Participating businesses may develop reward plans based on tokens 350 in order to incentivize users to buy and wear their products and smart articles 10. The more an individual wears a certain brand, the more brand-specific rewards the individual may obtain. A brand may try to drive sales patterns by making limited-edition “high token value” items and promising to pay a higher price for data collected through those items (such as smart articles 10) than through others, which would naturally incentivize users to buy those items and use them more often.

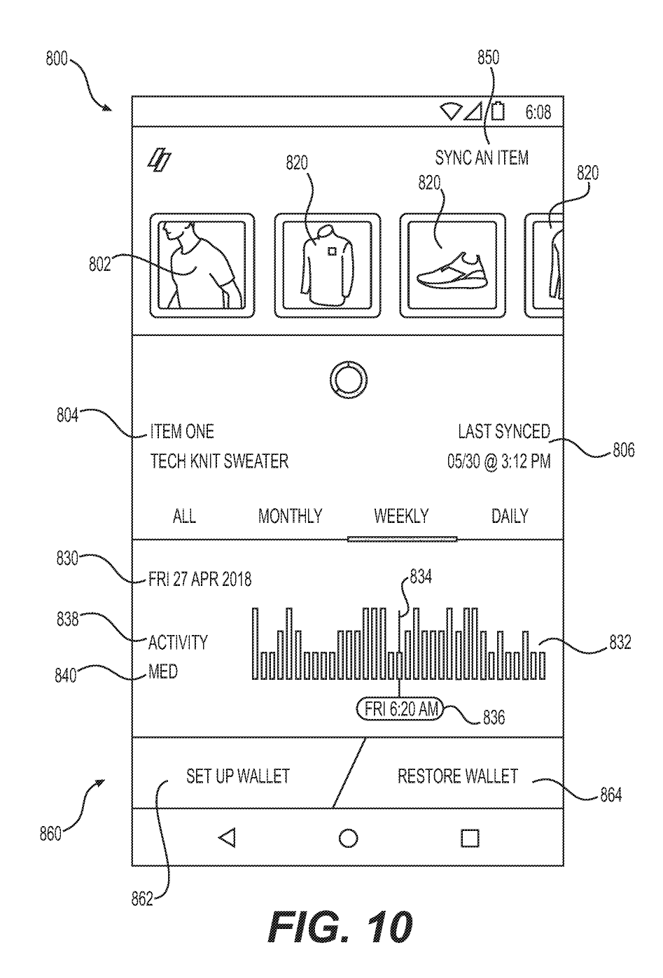

FIG. 10 depicts an exemplary user interface 800. User interface 800 may have any of the qualities of user interface 322 and/or user interface view 440, described above. User interface 800 may be displayed on any suitable device, including a personal computer, a tablet, a phone, or another mobile device. User interface 800 may include an icon or other indicator representing a smart article 802. Smart article 802 may have any of the qualities of smart article 10, described above. User interface 800 may include characteristics 804 regarding smart article 802. For example, characteristics 804 may include a brand, type, or name of smart article 802. User interface 800 may also include a status indicator 806, reflecting a status of smart article 802. Status indicator 806 may include information regarding a sync status, a battery status, a lifespan, or any other status of smart article 802. User interface 800 may also include icons or other indicators representing further smart articles 820, which may have any of the qualities of smart article 802. Clicking or tapping on a smart article 820 may causer user interface 800 to display information regarding smart article 820 and may replace the information displayed regarding smart article 802. For example, characteristics 804 and status indicator 806 may reflect information pertaining to smart article 820.

User interface 800 may also include information regarding a user's behavior or activity. Such displayed information may be tied to smart article 802 and/or smart articles 820. User interface 800 may include a day/date indicator 830, which may show a current day and/or date or a chosen day and/or date. User interface 800 may also include a graph 832 which may display data pertaining to a user and/or smart articles 802 and/or 820. For example, graph 832 may depict an activity level of a user, such as a number of calories burned, steps walked, flights of stairs climbed, hours standing, work productivity, checkpoints passed, or any other desired metric. Graph 832 may include an marker 834 of a particular time or other metric, which may be indicated with metric 836. For example, the time or other metric 836 depicted at marker 834 may be a current time or may be another time. The time or other metric 836 depicted at marker 834 may be chosen by a user or may result from machine analysis of data gathered by smart articles 802/820 or from other sources. User interface 800 may also reflect information about a metric 838. Metric 838 may reflect an activity level, a work productivity, a mobility (e.g., checkpoints passed), or any other desired metric (such as those described above with regard to graph 832). User interface 800 may include an evaluation 840 of metric 838. For example, evaluation 840 may reflect a performance of a user or smart articles 802/820 along metric 830. For example, as shown in FIG. 10, an activity level (metric 838) may be evaluated as being a medium level (evaluation 840). Evaluation 840 may be a qualitative (e.g., low, medium, high, etc.) and/or a quantitative measure (e.g., a number of steps, number of calories burned, number of uses, etc.). While activity metrics 838 and evaluations 840 are shown, any other information gathered regarding a user and/or smart articles 802/820 may be depicted in user interface 800.

User interface 800 may also include other functionality. For example, user interface 800 may include an icon 850 which can be activated by a user in order to sync an item, such as a further smart article 802/820, a smart tag 16, or any other device. Syncing may be achieved by any of the methods described above, including by scanning. User interface 800 may also include wallet functionality 860. Wallet functionality 862 may include a set up wallet function 862 and/or a restore wallet function 864. Wallet functionality 860 may additionally or alternatively include any other suitable functionality related to tile wallet 420 and/or tokens 350.

The systems, methods, and apparatuses disclosed herein have the power to serve a wide variety of functions for different enterprises. For example, researchers with no interest in product development might still want to make use of temperature, motion, and location data to, for example, study the safety conditions of industrial workers, to report in real time about the population-level effects of accidents and severe weather patterns, or to determine the best place in town to build a new housing development or franchise. If multiple third parties want to buy the same datasets collected from the same population of users, those users could receive royalties for each additional purchase.

The systems, methods, and apparatuses disclosed herein sit at the intersection of two new, fast-growing industries: smart goods (including apparel) and personal data. As such, they are uniquely well-positioned to unite these two burgeoning fields in service of each other. For example, smart apparel may require better data in order to drive product development, and personal data may need better smart apparel in order to track a larger number of internal and environmental variables in a more consistent, ongoing, and non-invasive way. Personal data is already a sought after commodity for businesses in many industries, but it will become an even more valuable resource in the decades ahead as developments in data science lead to cheaper, faster, and more revelatory forms of analysis on larger datasets than ever before. The systems, methods, and apparatuses disclosed herein provide a proactive, ethical plan for providing the high-volume, high-precision data sets that companies seek while eliminating the middle-men, closing the feedback loop, and ensuring that individuals will retain the right to own the data that they create.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Those of ordinary skill in the art will recognize that the systems, apparatuses, devices, and methods described herein can be applied to, or easily modified for use with, other types of applications.

It is intended that the specification and examples be considered as exemplary only, with a true scope and spirit of the invention being indicated by the following claims.

1. A method for exchanging user data for compensation comprising:
receiving data from a user pertaining to usage of a soft good, wherein the data is obtained from one or more sensors coupled to the soft good;
receiving bid information from a bidder, wherein the bid information pertains to an offer to purchase the data;
transmitting or displaying at least a portion of the data to the bidder; and
providing compensation to the user in exchange for providing the at least a portion of the data to the bidder.

2. The method of claim 1, further comprising displaying the bid information to the user.

3. The method of claim 1, further comprising comparing the bid information to a threshold value, and wherein the transmitting or displaying the at least a portion of the data to the bidder step occurs only if the bid information exceeds the threshold value.

4. The method of claim 1, further comprising obtaining a bid acceptance from the user.

5. The method of claim 1, wherein the soft good is a garment.

6. The method of claim 1, further comprising verifying an identity of the user.

7. The method of claim 1, wherein the data is received from a tag of the soft good, wherein the tag is fixedly attached to the soft good.

8. The method of claim 1, wherein the sensor continuously obtains data from the soft good.

9. The method of claim 1, wherein the sensor obtains data from the soft good at predetermined time intervals.

10. The method of claim 1, further comprising storing at least a portion of the data in offsite storage.

11. A system for facilitating exchanges of user data and compensation comprising:
at least one computer-readable medium having stored thereon:
a software platform configured to receive data pertaining to usage by a user of a soft good, wherein the data is obtained from one or more sensors coupled to the soft good; and
a data exchange platform configured to:
receive bid information from a bidder, wherein the bid information pertains to an offer to purchase the data;
provide at least a portion of the data to the bidder; and
provide compensation to the user in exchange for providing the at least a portion of the data to the bidder.

12. The system of claim 11, wherein the soft good is a garment.

13. The system of claim 11, wherein the data is obtained by scanning a tag of the soft good.

14. The system of claim 11, wherein the sensor continuously obtains data from the soft good.

15. The system of claim 11, wherein the sensor obtains data from the soft good at predetermined time intervals.

16. The system of claim 11, wherein the platform is configured to verify the identity of the user.

17. The system of claim 11, wherein the platform includes a wallet, and wherein the compensation is deposited to the wallet.

18. A method for exchanging user data for compensation comprising:
receiving data from a user pertaining to usage of a soft good, wherein the data is obtained from one or more sensors coupled to the soft good;
displaying to the user one or more bids for the data;
receiving from the user an acceptance of at least one of the bids;
transmitting or displaying at least a portion of the data to the bidder; and
providing compensation to the user in response to the user's acceptance of at least one of the bids.

19. The method of claim 18, wherein the data is received from a tag of the soft good, wherein the tile tag is fixedly attached to the soft good.

20. The method of claim 18, wherein the compensation is provided to the user using a virtual wallet.
